(19) United States
(12) Patent Application Publication
(10) Pub. No.: US 2025/0299863 A1
(43) Pub. Date: Sep. 25, 2025

(54) PLANAR TRANSFORMER

(71) Applicant: Hamilton Sundstrand Corporation, Charlotte, NC (US)

(72) Inventor: Edward Graham Charles POCOCK, Birmingham (GB)

(21) Appl. No.: 19/052,851

(22) Filed: Feb. 13, 2025

(30) Foreign Application Priority Data
Mar. 19, 2024 (EP) 24275029.7

(51) Int. Cl. H01F 27/10; H01F 27/28

(52) U.S. Cl. CPC H01F 27/10; H01F 27/2804; H01F 2027/2819

(57) ABSTRACT

A planar transformer includes a stack comprising a plurality of planar windings arranged one above the other, an outer core portion comprising a first plate and a second plate, an inner core portion extending between the first plate and the second plate, and at least one heat pipe. The planar windings are disposed between the first plate and the second plate. Each planar winding of the plurality of planar windings, the first plate and the second plate extend substantially parallel to each other. The at least one heat pipe extends substantially parallel to the plurality of planar windings and is disposed in a space formed between a planar winding of the plurality of planar windings and any of: another planar winding of the plurality of planar windings, the first plate, or the second plate.

### CROSS-REFERENCE TO RELATED APPLICATIONS

This application claims the benefit of European Patent Application No. 24275029.7 filed Mar. 19, 2024, the disclosure of which is incorporated herein by reference in its entirety.

### TECHNICAL FIELD

The present disclosure relates to planar transformers, for example for use in aircraft, and to the thermal management of such planar transformers.

### BACKGROUND

Planar transformers are used in applications such as in aerospace applications due to their compact design, saving space and weight. Traditional planar transformers dissipate heat from the windings through the winding insulation and into the core, on which a heat sink or other such heat dissipation means can be attached to dissipate the heat from the transformer. This creates a large thermal resistance between the windings and the heat sink, causing the windings to run at a higher temperature than desired which may limit the power of the transformer.

In some applications such as, for example, in the aerospace industry, there is a need to improve the thermal management of planar transformers and provide an improved heat dissipation pathway from the windings to a heat sink.

### SUMMARY

According to a first aspect of this disclosure, there is provided a planar transformer comprising a stack comprising a plurality of planar windings arranged one above the other, an outer core portion comprising a first plate and a second plate, an inner core portion extending between the first plate and the second plate, and at least one heat pipe, wherein the planar windings are disposed between the first plate and the second plate, wherein each planar winding of the plurality of planar windings, the first plate and the second plate extend substantially parallel to each other, and wherein the at least one heat pipe extends substantially parallel to the plurality of planar windings and is disposed in a space formed between a planar winding of the plurality of planar windings and any of: another planar winding of the plurality of planar windings, the first plate, or the second plate.

In any example of the disclosure, the at least one heat pipe may comprise a plurality of heat pipes disposed in the space. In any example of the disclosure, it will be understood that the space may be the same space.

In any example of the disclosure, a first heat pipe of the plurality of heat pipes may be disposed on a first side of the inner core portion and a second heat pipe of the plurality of heat pipes may be disposed on a second, opposite side of the inner core portion.

In any example of the disclosure, one or more third heat pipes of the plurality of heat pipes may be disposed adjacent to and substantially aligned with the first heat pipe to form a first set of heat pipes and one or more fourth heat pipes of the plurality of heat pipes may be disposed adjacent to and substantially aligned with the second heat pipe to form a second set of heat pipes.

In any example of the disclosure, the inner core portion may extend substantially perpendicular to and through the plurality of planar windings.

In any example of the disclosure, the planar transformer may comprise one or more further heat pipes disposed in a different space formed between a planar winding of the plurality of planar windings and any of: another planar winding of the plurality of planar windings, the first plate, or the second plate.

In any example of the disclosure, the at least one heat pipe may comprise a first end disposed within the stack and a second end external to the stack.

In any example of the disclosure, each of the one or more further heat pipes may comprise a first end disposed within the stack and a second end external to the stack.

In any example of the disclosure, the planar transformer may comprise at least one attachment block in thermal communication with the first end of the at least one heat pipe, wherein the at least one heat pipe and the attachment block are disposed between and in thermal connection with the same planar winding of the plurality of planar windings and the same one of: the another planar winding of the plurality of planar windings, the first plate, or the second plate.

In any example of the disclosure, the at least one attachment block may comprise one or more channels in which respective heat pipes of the at least one heat pipe are received.

In any example of the disclosure, the planar transformer may comprise at least one further attachment block in thermal communication with the one or more further heat pipes, wherein the one or more further heat pipes and the further attachment block are disposed between and in thermal connection with the same planar winding of the plurality of planar windings and the same one of: the another planar winding of the plurality of planar windings, the first plate, or the second plate

In any example of the disclosure, the further attachment block may comprise one or more channels in which respective heat pipes of the one or more further heat pipes are received.

In any example of the disclosure, the at least one heat pipe may be configured to extend partially around the inner core portion.

In any example of the disclosure, the one or more further heat pipes may be configured to extend partially around the inner core portion.

In any example of the disclosure, the planar transformer may comprise a break section through which the at least one heat pipe and/or the at least one attachment block and/or the one or more further heat pipes and/or the at least one further attachment block do not extend.

In any example of the disclosure, the plurality of planar windings may comprise a plurality of primary planar windings and a plurality of secondary planar windings.

In any example of the disclosure, each winding of the plurality of planar windings may comprise a copper plate, an aluminium plate or a printed circuit board.

In any example of the disclosure, the planar transformer may comprise a heat transfer block in thermal communication with the second end of the at least one heat pipe.

In any example of the disclosure, the planar transformer may comprise a plurality of electrically insulating layers, disposed between respective pairs of adjacent planar windings of the plurality of planar windings.

### BRIEF DESCRIPTION OF DRAWINGS

Certain examples of the disclosure will now be described by way of example only and with reference to the accompanying drawings in which:

FIG. 1 is a perspective view of a planar transformer from above according to an example of the disclosure;

FIG. 2A is a perspective cutaway view of the planar transformer of FIG. 1;

FIG. 2B is an underside perspective view of a core portion of the planar transformer of FIG. 1;

FIG. 3A is a side section view of the planar transformer of FIG. 1;

FIG. 3B is an enlarged section view of part of the stack of the planar transformer of FIG. 3A;

FIG. 4 is a front section view of the planar transformer of FIG. 1;

FIG. 5 is a perspective view of a rear portion of the planar transformer of FIG. 1;

FIG. 6 is an underside perspective view of the heat exchange assembly of the planar transformer of FIG. 1;

FIG. 7 is a perspective view from above of a planar transformer according to another example of the disclosure;

FIG. 8A is a side section view of the planar transformer of FIG. 7;

FIG. 8B is an enlarged section view of part of the stack of the planar transformer of FIG. 8A;

FIG. 9 is a front section view of the planar transformer of FIG. 7;

FIG. 10 is a perspective view of a rear portion of the planar transformer of FIG. 7; and

FIG. 11 is an underside perspective view of the heat exchange assembly of the planar transformer of FIG. 7.

### DETAILED DESCRIPTION

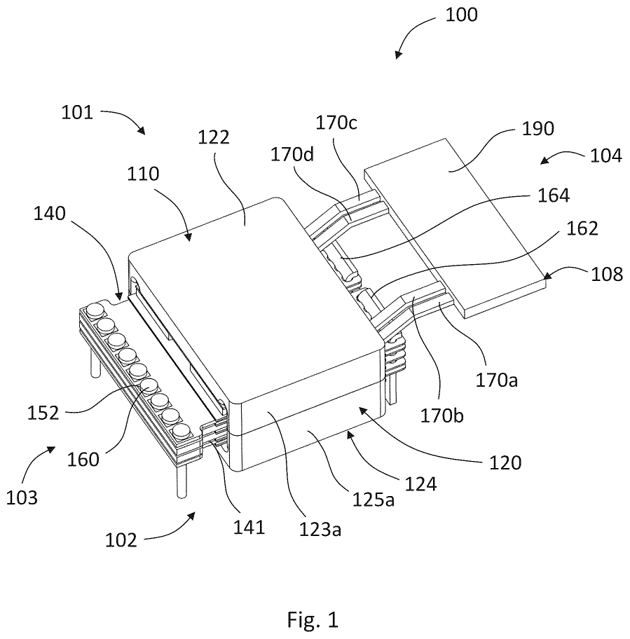

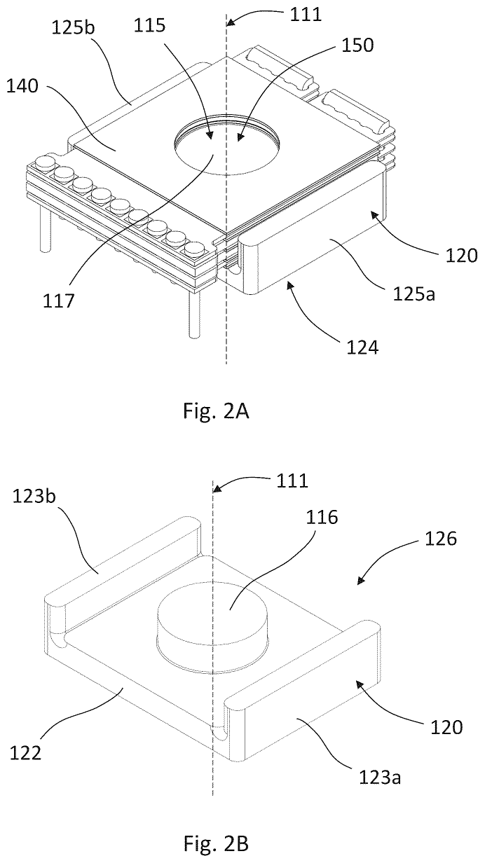

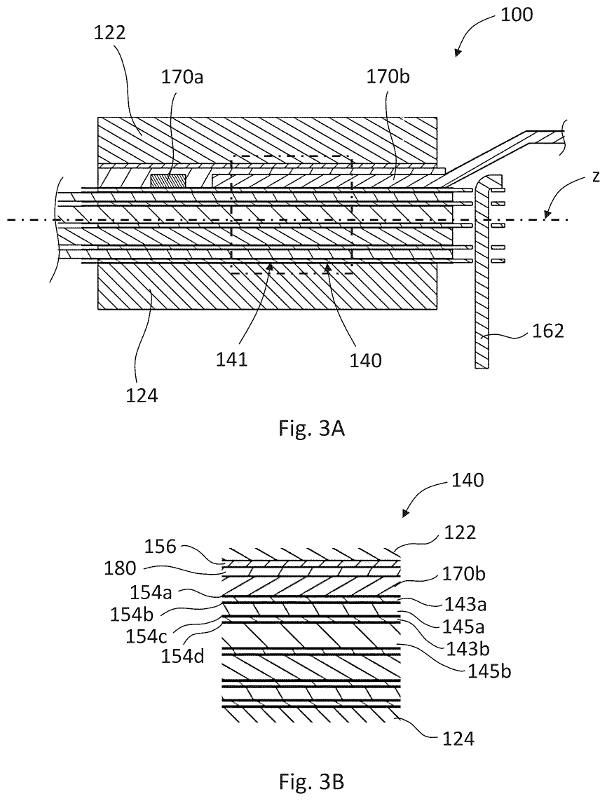

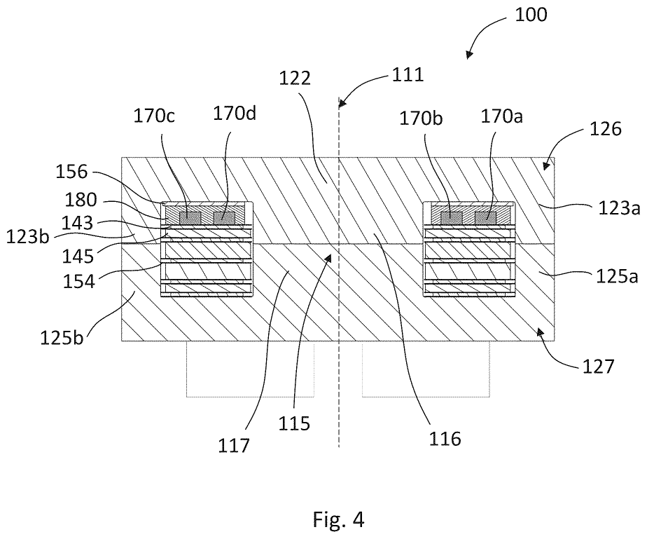

In any example, and referring to the planar transformer shown in FIG. 1, the disclosure may provide a planar transformer 100. The planar transformer 100 comprises a stack 140 and a core 110. The core 110 is seen in more detail in FIGS. 2A and 2B and the stack is shown in more detail in FIGS. 3A and 3B. Further details of the stack 140 and the core 110 arrangement are shown in FIG. 4. The stack 140 comprises a plurality of planar windings 141.

The core 110 comprises an inner core portion 115 and an outer core portion 120. The outer core portion 120 comprises a first plate 122 and a second plate 124. The first plate 122 may be disposed adjacent the stack, for example substantially above the stack 140 towards a first, or top end 101 of the transformer 100. The second plate 124 may be disposed adjacent the stack, for example substantially below the stack 140, towards a second, or bottom end 102 of the transformer 100. The inner core portion 115 extends within the outer core portion and between the first and second plates 122, 124. As will be described further below, the planar transformer 100 includes one or more heat pipes extending substantially parallel to the plurality of planar windings 141 and disposed between a planar winding 141 and any of: another planar winding 141, the first plate 124, or the second plate 124.

In some examples and as seen in the drawings, the outer core portion 120 is made up of a first section 126 and a second section 127, the first section 126 comprising the first plate 122 and first side portions 123a, 123b which extend from two opposite side edges of the first plate 122 towards the second plate 124. FIG. 2B shows the first section 126 viewed from the underside. The first and second sections 126, 127 are arranged in different orientations but are substantially the same shape. The second section 127 comprises second side portions 125a, 125b which extend from two opposite side edges of the second plate 124 towards the first plate 122. The first side portion 123a is in contact with the second side portion 125a, and the first side portion 123b is in contact with the second side portion 125b. In some examples and as shown in the drawings, the inner core portion 115 comprises a first inner core portion 116 extending from the first plate 122 towards the second plate 124. The inner core portion 115 also comprises a second inner core portion 117 extending from the second plate 124 towards the first plate 122. The first and second inner core portions 116, 117 are in contact with each other and together form the inner core portion 115. The core 110 partially encases the stack 140 such that two sides of the stack 140 are enclosed by the first and second side portions 123a, 123b, 125a, 125b. The core 110 has a first open end at a first, or front end 103 of the planar transformer 100 and a second open end at a second, or rear end 104 of the planar transformer 100. The stack 140 extends out of the core 110 through the first open end at the first end 103 of the transformer 100 and through the second open end at the second end 104 of the transformer 100. The stack 140 comprises a core through-hole 150, which may be formed through each of the planar windings 141 of the stack 140, through which the inner core portion 115 extends.

It will be understood that the plurality of planar windings could take various forms. In any example of the disclosure and as shown in the drawings, the planar windings 141 may be cuboid in shape. The planar windings 141 may be stacked one above the other in a z direction as seen in FIG. 3A for example, such that the edges of the planar windings 141 are substantially aligned with each other. The edges of the planar windings 141 may form the side walls or side edges of the stack 140. A space may be provided between each planar winding 141 and also between the first plate 122 and the second plate 124 and their respective adjacent planar windings 141.

It will be understood that the core 110 could take various forms. In any example of the disclosure and as shown in the drawings, the first plate 122 and the second plate 124 may be cuboid in shape. The inner core portion 115 may take any suitable form and could for example be cylindrical and/or be positioned to extend through the centre of the stack 140, for example with a longitudinal axis 111 of the inner core portion 115 extending substantially perpendicular to the first plate 122 and/or the second plate 124. In any example of the disclosure, the inner core portion 115 may extend from the first plate 122 to the second plate 124 along a longitudinal axis 111 thereof. The inner core portion 115 may have a width or diameter in a direction perpendicular to the longitudinal axis 111 thereof that is less that its length, in some examples significantly less. In any example of the disclosure, the inner core portion 115 may have a width or diameter perpendicular to the longitudinal axis 111 thereof that is less than the width of the planar windings 141 of the stack 140 such that the planar windings 141 surround and extend beyond the inner core portion 115 in a direction perpendicular to the longitudinal axis 111 thereof. It will be understood that the core through-hole 150 could take any suitable form, for example having a cylindrical form for receiving a cylindrical inner core portion 115.

A detailed stack configuration is shown in FIGS. 3A and 3B, FIG. 4, and FIG. 5. The stack 140 comprises a plurality of planar windings 141, in some examples three or more windings, in some examples four or more windings, in some examples five or more windings. The plurality of windings 141 are arranged in the stack 140 substantially parallel to one another. Each winding of the plurality of windings 141 extends substantially parallel to each other winding and substantially parallel to the first and second plates 122, 124. In some examples and as shown in the drawings, the plurality of planar windings 141 comprises a plurality of primary windings 143 and a plurality of secondary windings 145. The plurality of primary windings 143 are in electrical connection with each other and the plurality of secondary windings 145 are in electrical connection with each other. The stack 140 may be arranged such that the primary and secondary windings 143, 145 are arranged alternately within the stack 140, as shown in FIG. 3A. In other examples which are not shown, the primary windings may be arranged in a primary winding stack and the secondary windings may be arranged in a secondary winding stack, with the stacks on top of one another. In any example, each winding may comprise a copper or aluminium plate or sheet, or a printed circuit board (PCB). In any example where the windings comprise PCBs, one or more traces may be integrated into each PCB to form the winding.

In some examples and as shown in the example of FIGS. 1 to 6, the planar transformer 100 comprises a plurality of heat pipes 170 disposed above the plurality of windings 141 such that they are disposed between a planar winding 141 and the first plate 124. The plurality of heat pipes 170 may be positioned adjacent to one another, may be spaced from one another, may be substantially aligned in the z direction, and/or may extend substantially parallel to one another. As seen in FIGS. 3A and 3B, in these examples the heat pipes 170 are disposed on a first primary winding 143a of the plurality of windings 141. In any example of the disclosure, one or more attachment blocks 180 may be disposed over the or each heat pipe, for example over the plurality of heat pipes 170 in this example, such that the heat pipes 170 are located in channels of the attachment block(s) 180 as described in further detail below. The attachment blocks 180 and the heat pipes 170 may form a heat exchange layer. The attachment block 180 may be in thermal connection with the first primary winding 143a. In any example of the disclosure, the one or more heat pipes may extend out from the stack 140, for example through an open end thereof, for removal of heat from the stack 140. The heat pipes 170 in the example shown extend out from the stack 140 through the second open end at the second end 104 and are in thermal connection with a heat transfer block 190. The heat transfer block 190 may be external to the core 110. The heat transfer block may not be directly attached to the core 110.

In any example of the disclosure, the stack 140 may comprise a plurality of electrically insulating layers 154 disposed between each of the plurality of planar windings 141. In some examples and as shown, the insulating layers 154 are disposed between each of the primary and secondary windings 143, 145. The insulating layers provide electrical insulation between the primary and secondary windings 143, 145. As seen in FIG. 3B, an insulating layer 154a is provided on first primary winding 143a between the first primary winding 143a and the heat exchange layer comprising the heat pipes 170 and the attachment block 180. A compliant layer 156 may be disposed between the attachment block 180 and the core 110. In the example shown, the compliant layer 156 is disposed between the attachment block 180 and the first plate 122 of the core 110. The compliant layer 156 may comprise a thermally conductive but electrically insulative gap pad. The compliant layer 156 fills any gaps between the attachment block 180 and the core 110 providing contact pressure between the plurality of windings 141, heat pipes 170, attachment block 180 and core 110. The compliant layer 156 ensures sufficient heat is transferred through the plurality of windings 141 to the heat pipes 170.

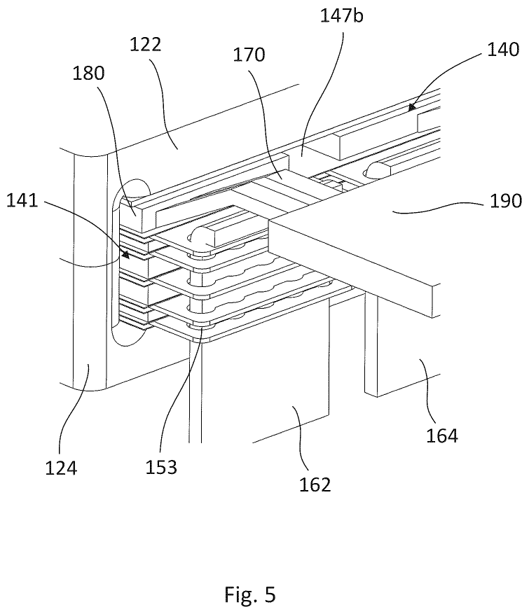

In any example of the disclosure, the stack 140 may comprise one or more take-off means for transporting electricity away from the transformer. In the examples shown, the take-off means comprise a first take-off pin 162 electrically connected to the primary windings 143 and a second take-off pin 164 electrically connected to the secondary windings 145 at the second end 104 of the transformer 100. The stack 140 may comprise holes through which these take-off pins 162, 164 extend. The take-off pins 162, 164 are shown in detail in FIG. 5.

The stack 140 may comprise pin holes 152 through which connecting pins 160 are located as seen for example in FIG. 1. The connecting pins 160 may secure the stack 140 and secure the windings in place.

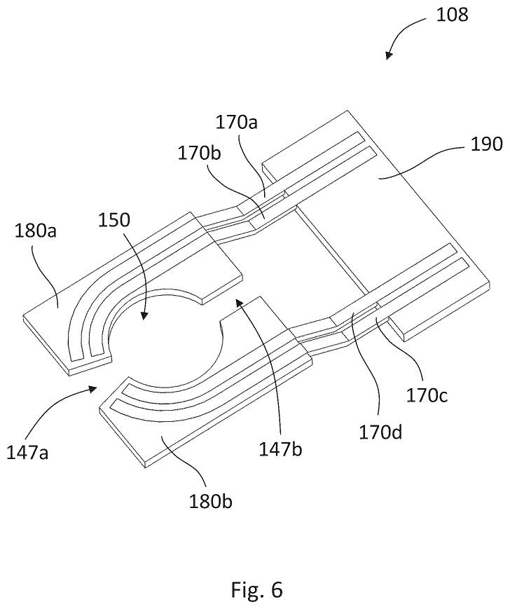

The planar transformer 100 may comprise a heat exchange assembly 108 comprising at least one heat pipe 170. In the example shown in FIG. 1 to 6, the heat exchange assembly 108 comprises four heat pipes 170a, 170b, 170c, 170d. Each of the heat pipes 170 extend from the stack 140 to a heat transfer block 190 as described above. In examples, the heat transfer block 190 may be a heat sink or a liquid cold plate. The heat exchange assembly 108 is shown in FIG. 6 in isolation. The heat exchange assembly 108 comprises a first set of heat pipes 170a, 170b and a second set of heat pipes 170c, 170d which are disposed on respective attachment blocks 180a, 180b. As seen in FIG. 6, the first set of heat pipes 170a, 170b may extend substantially parallel to, spaced from and in alignment with each other in the z direction. Similarly, the second set of heat pipes 170c, 170d may extend substantially parallel to, spaced from and in alignment with each other in the z direction. The first set of heat pipes 170a, 170b may be provided on a first side of the inner core portion 115 and the second set of heat pipes 170c, 170d may be provided on a second, opposite side of the inner core portion 115.

The attachment blocks 180a, 180b comprise channels in which the heat pipes 170 are disposed. The heat pipes 170 may be attached to the attachment blocks 180 by means of epoxy or soldering. The attachment blocks 180 are disposed on the first primary winding 143a. The heat pipes 170 extend away from the stack 140 towards the heat transfer block 190. In use, heat conducts from the plurality of windings 141 to the attachment blocks 180 and into the heat pipes 170. The heat pipes 170 transfer the heat from the stack and into the heat transfer block 190. In examples, different numbers of heat pipes may be used. The number of heat pipes used, may depend on the amount of heat required to be removed from the stack. The attachment blocks 180 may be made from aluminium or other conductive metal to allow for conduction of heat from the stack into the heat pipes.

In this example, the attachment blocks 180a, 180b and the heat pipes 170 do not extend around the inner core portion 115. The attachment blocks 180a, 180b do not touch, a gap being provided between them providing break sections 147a, 147b between the respective attachment blocks 180a, 180b and between respective heat pipes on the first and second sides of the inner core portion 115. These break sections 147a, 147b ensure that the heat pipes 170 and the attachment blocks 180 do not interfere with the windings and themselves create or act as a winding in which a current can be induced. In other examples, there may only be one attachment block and one heat pipe, or different numbers of each component.

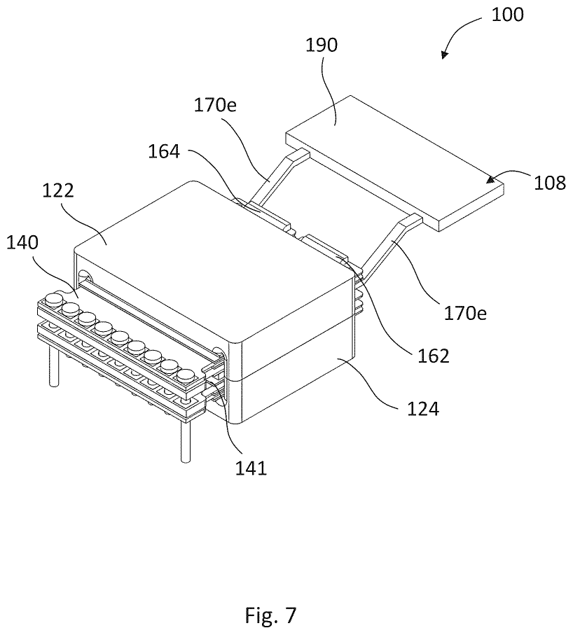

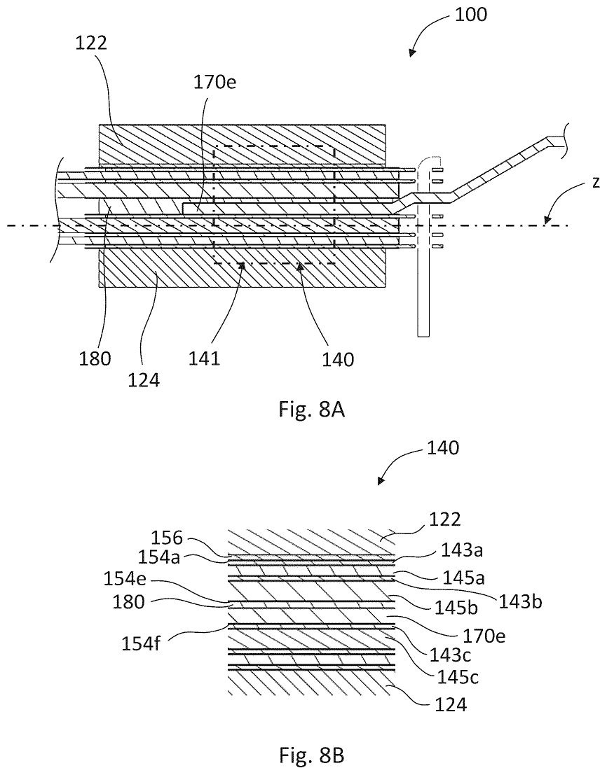

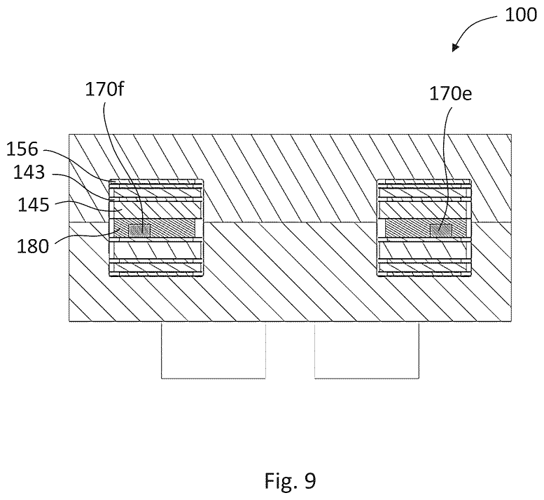

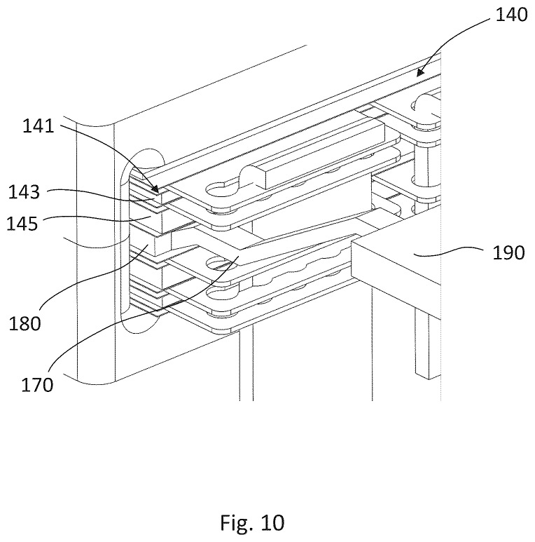

FIGS. 7 to 11 show another example of a planar transformer according to the disclosure, in which some of the features are substantially the same as disclosed in the example above. Those features which correspond to the features above have been given the same reference numbers and have not been described again here. This example differs from that described above in that the heat pipes 170e, 170f and the attachment block 180 are disposed within the stack 140, between the plurality of windings 141. In addition, the heat exchange assembly 108 comprises only two heat pipes 170e, 170f, as shown in FIG. 7 (it will of course be understood that any desired number of heat pipes could however be provided). FIGS. 8A, 8B, 9 and 10 show a detailed cross section view of the stack 140. The heat pipe 170e and attachment block 180 are disposed between secondary winding 145b and primary winding 143c. The electrically insulating layers 154 are disposed between each of the primary and secondary windings 143, 145. An insulating layer 154e is disposed between the secondary winding 145b and the attachment block 180. An insulating layer 154f is disposed on and between the primary winding 143c and the heat transfer layer that comprises the heat pipes 170 and attachment blocks 180. In this configuration, heat can be transferred away from the centre of the stack 140 to the heat pipes and to the heat transfer block 190. In this example, the compliant layer 156 is disposed at the top of the stack 140, between the plurality of windings 141 and the first plate 122.

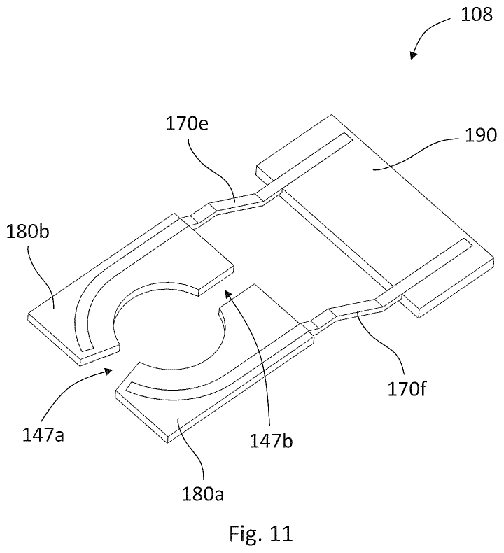

FIG. 11 shows the heat exchange assembly 108 comprising attachment blocks 180a and 180b, and heat pipes 170e, 170f. This example comprises two heat pipes, with each attachment block comprising a channel in which a single heat pipe is received. In other examples, different numbers of attachment blocks and heat pipes may be used.

It will be understood that where two components are described as extending substantially parallel to one another, this is intended to mean that they extend at the same angle as each other or that the first component extends at an angle within the range of 0 to 25 degrees, or 0 to 20 degrees or 0 to 15 degrees, or 0 to 10 degrees, or 0 to 5 degrees relative to the other component. In a similar manner, substantially perpendicular is intended to mean within the range of 0 to 25 degrees, or 0 to 20 degrees or 0 to 15 degrees, or 0 to 10 degrees, or 0 to 5 degrees relative to the perpendicular.

While the disclosure has been described in detail in connection with only a limited number of examples, it should be readily understood that the disclosure is not limited to such disclosed examples. Rather, the disclosure can be modified to incorporate any number of variations, alterations, substitutions or equivalent arrangements not heretofore described, but which are commensurate with the scope of disclosure. For example, any desired number and arrangement of heat pipes could be provided in the planar transformer and can be located between any first and second planar windings, and/or between a planar winding and one of the plates of the outer core portion.

Additionally, while various examples of the disclosure have been described, it is to be understood that aspects of the disclosure may include only some of the described examples. Accordingly, the disclosure is not to be seen as limited by the foregoing description, but is only limited by the scope of the appended claims.

1. A planar transformer comprising:
an outer core portion comprising a first plate and a second plate;
an inner core portion extending between the first plate and the second plate; and
a stack comprising a plurality of planar windings arranged one above the other, wherein the plurality of planar windings are disposed between the first plate and the second plate, and wherein each planar winding of the plurality of planar windings, the first plate and the second plate extend substantially parallel to each other; and
at least one heat pipe,
wherein the at least one heat pipe extends substantially parallel to the plurality of planar windings and is disposed in a space formed between a planar winding of the plurality of planar windings and any of: another planar winding of the plurality of planar windings, the first plate, or the second plate.

2. The planar transformer as claimed in claim 1, wherein the at least one heat pipe comprises a plurality of heat pipes disposed in the space.

3. The planar transformer as claimed in claim 2, wherein a first heat pipe of the plurality of heat pipes is disposed on a first side of the inner core portion and a second heat pipe of the plurality of heat pipes is disposed on a second, opposite side of the inner core portion.

4. The planar transformer as claimed in claim 3, wherein one or more third heat pipes of the plurality of heat pipes are disposed adjacent to and substantially aligned with the first heat pipe to form a first set of heat pipes and wherein one or more fourth heat pipes of the plurality of heat pipes are disposed adjacent to and substantially aligned with the second heat pipe to form a second set of heat pipes.

5. The planar transformer as claimed in claim 1, wherein the inner core portion extends substantially perpendicular to and through the plurality of planar windings.

6. The planar transformer as claimed in claim 1, further comprising:
one or more further heat pipes disposed in a different space formed between a planar winding of the plurality of planar windings and any of: another planar winding of the plurality of planar windings, the first plate, or the second plate.

7. The planar transformer as claimed in claim 1, wherein the at least one heat pipe comprises a first end disposed within the stack and a second end external to the stack.

8. The planar transformer as claimed in claim 7, further comprising:
at least one attachment block in thermal communication with the first end of the at least one heat pipe, wherein the at least one heat pipe and the at last one attachment block are disposed between and in thermal connection with a same planar winding of the plurality of planar windings a the same one of: the another planar winding of the plurality of planar windings, the first plate, or the second plate.

9. A planar transformer as claimed in claim 8, wherein the at least one attachment block comprises one or more channels in which respective heat pipes of the at least one heat pipe are received.

10. The planar transformer as claimed in claim 1, wherein the at least one heat pipe is configured to extend partially around the inner core portion.

11. A planar transformer as claimed in claim 10, comprising a break section through which the at least one heat pipe and/or the at least one attachment block do not extend.

12. The planar transformer as claimed in claim 1, wherein the plurality of planar windings comprises a plurality of primary planar windings and a plurality of secondary planar windings.

13. The planar transformer as claimed in claim 7, further comprising:
a heat transfer block in thermal communication with the second end of the at least one heat pipe.

14. The planar transformer as claimed in claim 1, further comprising:
a plurality of electrically insulating layers, disposed between respective pairs of adjacent planar windings of the plurality of planar windings.

15. The planar transformer as claimed in claim 8, further comprising:
one or more further heat pipes disposed in a different space formed between a planar winding of the plurality of planar windings and any of: another planar winding of the plurality of planar windings, the first plate, or the second plate; and
at least one further attachment block in thermal communication with the one or more further heat pipes, wherein the one or more further heat pipes and the further attachment block are disposed between and in thermal connection with the same planar winding of the plurality of planar windings and the same one of: the another planar winding of the plurality of planar windings, the first plate, or the second plate.

16. The planar transformer as claimed in claim 15, wherein the further attachment block comprises one or more channels in which respective heat pipes of the one or more further heat pipes are received.
